(19) United States
(12) Patent Application Publication
(10) Pub. No.: US 2026/0103104 A1
(43) Pub. Date: Apr. 16, 2026

(54) DEVICE AND METHOD FOR MANAGING CHARGING AND DISCHARGING OF ELECTRIC VEHICLE

(71) Applicants: HYUNDAI MOTOR COMPANY, Seoul (KR); KIA CORPORATION, Seoul (KR); Gwangju Institute of Science and Technology, Gwangju (KR)

(72) Inventors: Bum Su Park, Hwaseong-si (KR); Jeong Hoon Choi, Hwaseong-si (KR); Jae Yun Jung, Hwaseong-si (KR); Hyun Sup Kim, Hwaseong-si (KR); Sung Kyu Kim, Hwaseong-si (KR); Dae Gun Ko, Hwaseong-si (KR); Seong Hyeok Ko, Gwangju (KR); Joon Byeok Hwang, Gwangju (KR); Jin Sol Hwang, Gwangju (KR); Woan Ho Park, Gwangju (KR); Yun Su Kim, Gwangju (KR)

(73) Assignees: HYUNDAI MOTOR COMPANY, Seoul (KR); KIA CORPORATION, Seoul (KR); Gwangju Institute of Science and Technology, Gwangju (KR)

(21) Appl. No.: 19/202,705

(22) Filed: May 8, 2025

(30) Foreign Application Priority Data
Oct. 11, 2024 (KR) 10-2024-0138459

(51) Int. Cl. B60L 53/67; B60L 53/14; B60L 53/65; B60L 58/13

(52) U.S. Cl. CPC B60L 53/67; B60L 53/14; B60L 53/65; B60L 58/13; B60L 2260/58

(57) ABSTRACT

A device for managing charging and discharging of an electric vehicle is provided. The device includes one or more processors, and a memory configured to store one or more programs executed by the one or more processors, wherein the processor includes a first processing unit configured to cluster a plurality of electric vehicles and generate at least one cluster, a second processing unit configured to limit charging and discharging conditions for each time period according to charging and discharging conditions of individual electric vehicles belonging to the cluster, and a third processing unit configured to provide the limited charging and discharging conditions for each time period to integrate battery resources of electric vehicles in the cluster and generate one virtual battery for each cluster.

### CROSS-REFERENCE TO RELATED APPLICATION(S)

This application claims priority to and the benefit of Korean Patent Application No. 10-2024-0138459, filed on Oct. 11, 2024, the disclosure of which is incorporated herein by reference in its entirety.

### TECHNICAL FIELD

The present disclosure relates to a device and method for managing charging and discharging of an electric vehicle.

### BACKGROUND

With the enactment of the Special Act on Activation of Distributed Energy, opportunities are opening up for distributed resources including electric vehicles, to participate in the electricity market when they are gathered together. Accordingly, systems that allow virtual power plant (VPP) operators and distribution system operators (DSOs) to bid for distributed resources in the electricity market are introduced.

For example, many markets, such as various auxiliary service markets (demand response markets), small-scale power brokering, etc., have recently been opened, and more diverse markets, such as VPP markets, real-time power trading markets, etc., are being opened or reorganized.

However, in relation to an increase in complexity of optimization techniques, as the size of electric vehicles and charging stations increases, control variables of a charging/discharging algorithm also increase. In terms of energy management, when a computation time of the algorithm is rapidly increasing, control variables may become difficult to manage.

Accordingly, it may be useful to develop a system for performing efficient management using a large number of electric vehicles and chargers as a (e.g., single) resource.

### SUMMARY

The present disclosure is directed to providing a device and method for managing charging and discharging of an electric vehicle, such that the device is capable of operating and managing a (e.g., large) number of electric vehicles as a (e.g., one) resource.

According to an aspect of the present disclosure, there is provided a device for managing charging and discharging of an electric vehicle, which includes one or more processors, and a memory configured to store one or more programs executed by the one or more processors, wherein the processor includes a first processing unit configured to cluster a plurality of electric vehicles and generate at least one cluster, a second processing unit configured to limit charging and discharging conditions for each time period according to charging and discharging conditions of individual electric vehicles belonging to the cluster, and a third processing unit configured to reflect (e.g., provide) the limited charging and discharging conditions for each time period to integrate battery resources of electric vehicles in the cluster and generate one virtual battery for each cluster.

The charging and discharging conditions of the individual electric vehicles may include at least one of plug-in charger information, a current state of charge (SoC), a target SoC, resource type information, battery capacity information, battery charging and discharging efficiency, scheduled vehicle entry time information, and scheduled vehicle exit time information.

The second processing unit may calculate a first boundary that defines a power range of the virtual battery and a second boundary that defines an energy range of the virtual battery for each time slot according to the charging and discharging conditions of the individual electric vehicles.

The second processing unit may limit the first boundary and the second boundary to follow the target SoC at a scheduled vehicle exit time according to the scheduled vehicle exit time information.

When it is determined that following of the target SoC is not possible at the scheduled vehicle exit time during discharging in a first time slot, the second processing unit may limit a discharging range in the first time slot.

When it is determined that charging in a second time slot exceeds the battery capacity information, the second processing unit may limit a charging range in the second time slot.

The third processing unit may sum resources of the individual electric vehicles according to the first boundary and the second boundary for each time slot and generate the virtual battery.

The second processing unit may reflect an output of a charger and limit the charging and discharging conditions of the individual electric vehicles.

The second processing unit may reflect battery charging and discharging efficiency and limit the first boundary and the second boundary.

The device for managing charging and discharging of an electric vehicle may further include a fourth processing unit configured to generate a charging and discharging schedule of the electric vehicle using the virtual battery.

According to another aspect of the present disclosure, there is provided a method of managing charging and discharging of an electric vehicle, which is performed by a computing device including one or more processors and a memory configured to store one or more programs executed by the one or more processors, the method including clustering, by the processor, a plurality of electric vehicles and generating, by the processor, at least one cluster, limiting, by the processor, charging and discharging conditions for each time period according to charging and discharging conditions of individual electric vehicles belonging to the cluster, and reflecting, by the processor, the limited charging and discharging conditions for each time period to integrate battery resources of electric vehicles in the cluster and generating one virtual battery for each cluster.

The charging and discharging conditions of the individual electric vehicles may include at least one of plug-in charger information, a current SoC, a target SoC, resource type information, battery capacity information, battery charging and discharging efficiency, scheduled vehicle entry time information, and the scheduled vehicle exit time information.

The limiting of the charging and discharging conditions for each time period may include calculating a first boundary that defines a power range of the virtual battery for each time slot according to the charging and discharging conditions of the individual electric vehicles, and calculating a second boundary that defines an energy range of the virtual battery for each time slot according to the charging and discharging conditions of the individual electric vehicles.

The limiting of the charging and discharging conditions for each time period may include limiting the first boundary and the second boundary to follow the target SoC at a scheduled vehicle exit time according to the scheduled vehicle exit time information.

The limiting of the charging and discharging conditions for each time period may include limiting a discharging range in a first time slot when it is determined that the following of the target SoC is not possible at the scheduled vehicle exit time during discharging in the first time slot.

The limiting of the charging and discharging conditions for each time period may include limiting a charging range in a second time slot when it is determined that charging in the second time slot exceeds the battery capacity information.

The generating of the virtual battery may include summing resources of the individual electric vehicles according to the first boundary and the second boundary for each time slot and generating the virtual battery.

The limiting of the charging and discharging conditions for each time period may include reflecting an output of a charger and limiting the charging and discharging conditions of the individual electric vehicles.

The limiting of the charging and discharging conditions for each time period may include reflecting the battery charging and discharging efficiency and limiting the first boundary and the second boundary.

The method may further include generating charging and discharging schedules of the electric vehicle using the virtual battery.

### BRIEF DESCRIPTION OF THE DRAWINGS

The above and other objects and features of the present disclosure will become apparent to those of ordinary skill in the art by describing example embodiments thereof in detail with reference to the accompanying drawings, in which:

FIG. 1 is a view for describing a system for managing power of an electric vehicle according to an example embodiment;

FIG. 2 is a configuration block diagram illustrating a device for managing charging and discharging of an electric vehicle according to an example embodiment;

FIG. 3 is a view for describing the operation of the device for managing charging and discharging of an electric vehicle according to the embodiment;

FIGS. 4 and 5 are views for describing the operation of a second processing unit according to an example embodiment;

FIGS. 6 and 7 are views for describing the operation of a second processing unit according to another embodiment;

FIG. 8 is a view for describing the operation of a third processing unit according to an example embodiment;

FIGS. 9 and 10 are views for describing a virtual battery according to an example embodiment;

FIG. 11 is a view for describing charging and discharging schedules using the V B according to an example embodiment;

FIGS. 12, 13, and 14 are views for describing reliability of charging and discharging scheduling generated according to an example embodiment; and

FIG. 15 is a flowchart illustrating a method of scheduling electric vehicle charging and discharging according to an example embodiment.

### DETAILED DESCRIPTION

Hereinafter, example embodiments of the present disclosure will be described in detail with reference to the accompanying drawings.

However, the technical spirit of the present disclosure is not limited to the described embodiments, but may be implemented in various different forms, and one or more of the components among the embodiments may be used by being selectively coupled or substituted without departing from the scope of the technical spirit of the present disclosure.

In addition, terms (including technical and scientific terms) used in embodiments of the present disclosure may be construed to be generally understood by those skilled in the art to which the present disclosure pertains unless specifically defined and described, and the meanings of the commonly used terms, such as terms defined in a dictionary, may be construed in consideration of contextual meanings of related technologies.

In addition, the terms used in the embodiments of the present disclosure are for describing the embodiments and are not intended to limit the present disclosure.

In the specification, a singular form may include a plural form unless otherwise specified in the phrase, and when described as “at least one (or one or more) of A, B, and C,” one or more (e.g., among all) possible combinations of A, B, and C may be included.

In addition, terms such as first, second, A, B, (a), and (b) may be used to describe components of the embodiments of the present disclosure.

These terms are for distinguishing one component from another component, and the nature, sequence, order, or the like of the corresponding components is not limited by these terms.

In addition, when a first component is described as being “connected,” “coupled,” or “joined” to a second component, it may include a case in which the first component is directly connected, coupled, or joined to the second component, but also a case in which the first component is “connected,” “coupled,” or “joined” to the second component by another component present between the first component and the second component.

In addition, when the first component is described as being formed or disposed on “on (above) or below (under)” the second component, “on (above)” or “below (under)” may include not only a case in which two components are in direct contact with each other, but also a case in which one or more third components are formed or disposed between the two components. In addition, when described as “on (above) or below (under),” it may include the meaning of not only an upward direction but also a downward direction based on one component.

Hereinafter, embodiments will be described in detail with reference to the accompanying drawings, and the same or corresponding components are denoted by the same reference numeral regardless of the reference numerals, and overlapping descriptions thereof may be omitted.

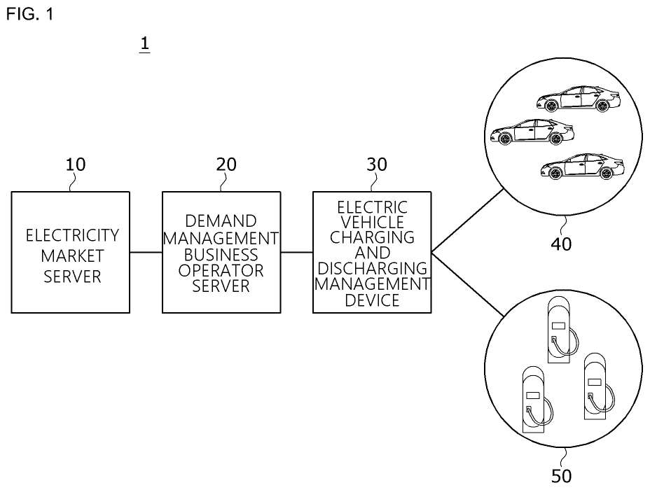

FIG. 1 is a view for describing a system for managing power of an electric vehicle according to an example embodiment. Referring to FIG. 1, a system 1 for managing power of an electric vehicle may include a power market server 10, a demand management business operator server 20, and a device 30 for managing charging and discharging of an electric vehicle.

The power market server 10 is a main device that operates a power market and may perform settlement according to the participation amount of each resource in different ways according to the market settlement rules. The power market server 10 may mediate power transactions between the demand management business operator servers 20 using power transaction request information received from a plurality of demand management business operator servers 20.

The power market server 10 may be a server that contracts with a demand management business operator to contract power usage and discharge business amount and distributes profits to the demand management business operator through demand response and a power unit price for each time period.

The demand management business operator server 20 may perform power transactions using charging and discharging information received from the connected device 30 for managing charging and discharging of an electric vehicle, renewable energy generation amount information of a connected renewable energy generation system, and power demand information of a connected system.

In an example embodiment, the demand management business operator may be a business operator who contracts with places that use a large amount of electricity, such as a factory, a big building, a parking tower, and the like to perform power consumption reduction or the like according to demand response, thus gaining profits.

The power system connected to the demand management business operator may transmit power demand information to the demand management business operator server 20 at a preset cycle, at the request of the demand management business operator server, or as needed. The power demand information may include the hourly power demand amount and the power usage reduction demand amount of the connected system.

The demand management business operator server 20 may respond to a demand response through a power usage reduction request, and also may serve as a power plant that reversely transmits electricity that can be used (e.g., directly) in the system using electric vehicles 40, electric vehicle batteries, an energy storage system (ESS), or the like.

For example, the demand management business operator server 20 may receive a next day's charging and discharging amount of the device 30 for managing charging and discharging of an electric vehicle at a specific time every day, bid the charging and discharging amount to the power market server side, receive the contracted amount from the power market server 10 according to the preset cycle, and transmit the contracted amount to the device 30 for managing charging and discharging of an electric vehicle.

The device 30 for managing charging and discharging of an electric vehicle may (e.g., directly) manage the electric vehicles 40, charging stations 50 of customers who participate in a vehicle to everything (V2X) service and receive information on the electric vehicles 40 and chargers, plug-in/out signals, and the like. The device 30 for managing charging and discharging of an electric vehicle may determine a next day's charging and discharging bid amount with the goal of maximizing market participation profits and control the charging and discharging of individual electric vehicles 40 to fulfill the contracted amount.

The device 30 for managing charging and discharging of an electric vehicle may monitor information on the electric vehicles 40 and the charging stations 50 and provide various data for customers. The device 30 for managing charging and discharging of an electric vehicle may perform functions of settling bills, managing a parking space, generating and transmitting charging and discharging control instructions, controlling charging and discharging scenarios, diagnosing a battery state of a vehicle, and the like.

The device 30 for managing charging and discharging of an electric vehicle may include a controller 31.

The power system may include, for example, a smart grid-related system such as a substation, a power market server, a demand management business operator server, renewable sources, an ESS, and/or the like. The renewable energy sources may be energy sources using wind power, solar power, geothermal heat, waste, and the like. The power system may supply power within an allowable power (or maximum power Pmax) (or allowable AC current IACmax) range to the charging stations 50 under the control of the controller 31.

In some cases, when a plurality of electric vehicles 40 are concentrated on the charging stations 50 in a specific region at the same time, the maximum allowable power of the power system may vary. That is, the power market server 10, the demand management business operator server 20 or an energy management system (EMS) that controls the operation of the power system may increase the power capacity by inputting a reserve power source such as an ESS or a nearby renewable energy source and supply the increased power capacity to the charging stations.

The allowable power may be increased under the control of the controller 31 when the power supplied to the electric vehicles 40 is insufficient due to the charging demand information of each electric vehicle 40 (charging demand amounts of electric vehicle users). That is, the controller 31 may control a switch to additionally connect (input) a renewable energy source (or an ESS) within the power system to a substation that supplies power to the charging stations 50 so that the allowable power of the power system increases when a charging load (a load of the electric vehicle) of the charging station 50 exceeds the allowable power of the power system.

The controller 31 may control the overall operation of the components included in the device 30 for managing charging and discharging of an electric vehicle. The controller 31 is an aggregator and may collect the battery capacity of the electric vehicle 40 connected to the charging station 50 through a wired or wireless communication network, a state of charge (SoC) of the battery of the electric vehicle 40, a rated current flowing through a power line, a rated voltage applied to the power line, or the charging demand information of an electric vehicle user (e.g., an owner). The charging demand information of the electric vehicle user may be transmitted to the controller 31 through a communication device included in each of the charging stations 50 or transmitted to the controller 31 through a communication device such as the user's portable phone.

The controller 31 may exchange information with the power system through a wired or wireless communication network and exchange data with the charging station 50 through LAN connection such as Ethernet, power line communication (PLC), or Wi-Fi, which is a wired or wireless communication network.

Based on real-time information of the power system, state information of the electric vehicle 40, and charging demand information of each electric vehicle 40, the controller 31 may control the power of the power system to be supplied to the charging station 50 within the allowable power range of the power system.

The real-time information of the power system may include the allowable power information of the power system or the electricity rate information of the power system, the state information of the electric vehicle 40 may include the SoC information of the battery included in each electric vehicle 40, and the charging demand information may include a charging demand time of an electric vehicle user, a scheduled vehicle entry time, a scheduled vehicle exit time, and a charging demand amount (a target SoC).

The charging station 50 may charge the batteries of the plurality of electric vehicles 40. Each of the charging stations 50 may include an AC limiter that performs a current allocation operation for each electric vehicle 40. In addition, each of the charging stations 50 may include a battery management system (BM S) of the electric vehicle 40 and a control module for exchanging information with the controller 31. Under the control of the controller 31, the control module may control the current limiter (the AC limiter) to provide a DC charging current to the battery of each of the electric vehicles 40.

Each of the electric vehicles 40 may include a BMS. The BMS may control a battery charging process. Each of the electric vehicles 40 may serve as an active load that requests power from the device 30 for managing charging and discharging of an electric vehicle for a charging time.

A charger for converting an AC current into a DC current of the power system to charge the battery of the electric vehicle 40 may be an on-board charger included in each of the electric vehicles 40 or an off-board charger included in each of the charging stations 50.

The electric vehicle 40 may register on a V2X platform and participate in power trading. A user of the electric vehicle 40 may join the platform according to the power market in which he or she wants to participate and register a predicted vehicle entry and exit schedule for the next day. The electric vehicle 40 may transmit information, such as a predicted plug-in time, a predicted plug-out time, SoC information, available battery capacity, and/or the like, to the device 30 for managing charging and discharging of an electric vehicle.

The system 1 for managing power of an electric vehicle is a centralized control system and may adjust charging and discharging schedules of electric vehicles considering the hourly power price, the demand and supply of the power system, or the like. However, as the number of electric vehicles that are in a control target increases, the amount of calculation and complexity for optimal scheduling increases.

The device 30 for managing charging and discharging of an electric vehicle according to the embodiment can optimize the charging and discharging of such a large-scale electric vehicle fleet.

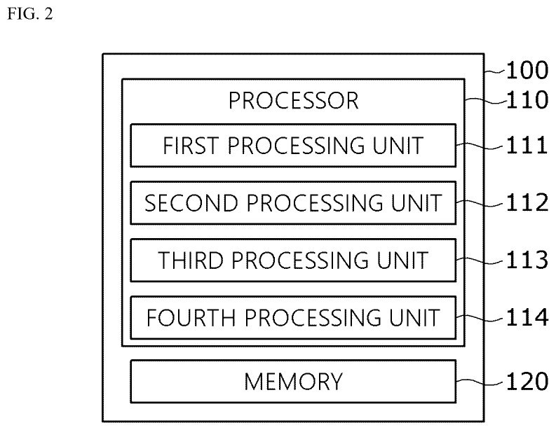

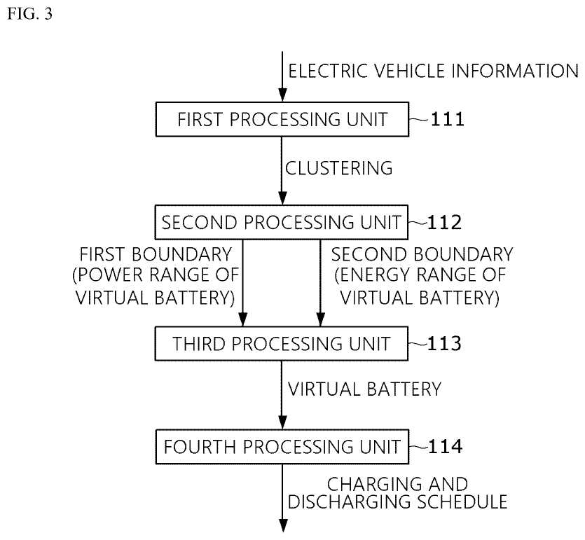

FIG. 2 is a configuration block diagram illustrating a device for managing charging and discharging of an electric vehicle according to an example embodiment, and FIG. 3 is a view for describing the operation of the device for managing charging and discharging of an electric vehicle according to the embodiment.

Referring to FIGS. 2 and 3, the device 100 for managing charging and discharging of an electric vehicle may include a processor 110 and a memory 120. In addition, the processor 110 according to the embodiment may include a first processing unit 111, a second processing unit 112, a third processing unit 113, and a fourth processing unit 114.

The device 100 for managing charging and discharging of an electric vehicle according to the embodiment may be implemented in a logic circuit by hardware, firmware, software, or a combination thereof and may also be implemented using a general-purpose or special-purpose computer. The device may be implemented using a hardwired device, a field programmable gate array (FPGA), an application specific integrated circuit (A SIC), and/or the like. In addition, the device 100 for managing charging and discharging of an electric vehicle may be implemented as a system on chip (SoC) including one or more processors and controllers.

In addition, the device 100 for managing charging and discharging of an electric vehicle may be mounted on a computing device or server provided with hardware elements in the form of software, hardware, or a combination thereof. The computing device or the server may be various devices including (e.g., all or some of) a communication device such as a communication modem for communicating with various devices or wired and wireless communication networks, a memory in which data for executing a program is stored, a microprocessor for executing a program to perform calculations and instructions, and the like.

The memory 120 may include a database (DB). The memory 120 may be a non-transitory storage medium for storing instructions executed by the processor. The memory 120 may include at least one of a random access memory (RAM), a static random access memory (SRAM), a read only memory (ROM), a programmable read only memory (PROM), an electrically erasable and programmable ROM (EEPROM), an erasable and programmable ROM (EPROM), a hard disk drive (HDD), a solid state disk (SSD), an embedded multimedia card (eMMC), a universal flash storage (UFS), and/or a web storage.

In an example embodiment, the first processing unit 111 to the fourth processing unit 114 may be implemented through the same process, and for convenience of description, the operation of each component will be described separately below.

The processor 110 may include at least one of processing devices such as an ASIC, a digital signal processor (DSP), a programmable logic device (PLD), an FPGA, a central processing unit (CPU), a microcontroller, and/or a microprocessor.

In an example embodiment, the device 100 for managing charging and discharging of an electric vehicle may receive electric vehicle information through a communication device and store the electric vehicle information in the DB. The electric vehicle information may include plug-in charger information, a current SoC, a target SoC, resource type information, battery capacity information, battery charging and discharging efficiency, scheduled vehicle entry time information, and scheduled vehicle exit time information.

The first processing unit 111 may cluster a plurality of electric vehicles to generate at least one cluster. The first processing unit 111 may cluster electric vehicles registered in a vehicle-to-grid (V2G) platform that operates the device 100 for managing charging and discharging of an electric vehicle according to the embodiment.

For example, the first processing unit 111 may cluster the plurality of electric vehicles according to charging and discharging conditions for each time slot and generate at least one electric vehicle cluster. The time slot may be a preset time interval, and the same time interval may be present between time slots.

The first processing unit 111 may collect battery capacities of electric vehicles, charging states of batteries of electric vehicles, a rated currents flowing through power lines, a rated voltage applied to the power lines, or charging and discharging conditions of electric vehicles through a communication device. The charging and discharging conditions of the electric vehicles may include information such as a predicted SoC, a predicted plug-in time, a predicted plug-out time, and/or the like.

The charging and discharging conditions of the electric vehicles may be transmitted to the first processing unit 111 through a communication device included in each of the charging stations or transmitted to the first processing unit 111 through a communication device such as the user's portable phone.

The first processing unit 111 may cluster a plurality of electric vehicles according to the charging and discharging conditions. For example, the first processing unit 111 may cluster the plurality of electric vehicles using a K-means clustering algorithm according to a preset number of electric vehicles per cluster.

K-means clustering is a method of unsupervised learning and is a technique for dividing given data into k clusters. Such an algorithm may assign each data point to the nearest centroid to form a cluster and optimize the quality of clustering by repeatedly recalculating the centroid of each cluster.

The first processing unit 111 may preset the number of clusters k according to the preset number of electric vehicles per cluster. The first processing unit 111 may randomly select k centroids from a dataset and assign each data point to the nearest centroid to form a cluster. In this case, the data point may be set according to the charging and discharging conditions of the electric vehicle. For example, the data point may be determined to be three-dimensional coordinates according to a predicted SoC, a predicted plug-in time, and a predicted plug-out time. The first processing unit 111 may determine the nearest centroid using a distance such as a Euclidean distance.

The first processing unit 111 recalculates the centroid of each cluster as an average of data points belonging to the corresponding cluster and repeats such a process until the centroid no longer changes or the cluster assignment converges.

When the centroids do not change or the maximum number of repetitions is reached, the first processing unit 111 may end the algorithm and return the final cluster and the centroids.

The second processing unit 112 may limit the charging and discharging conditions for each time period according to the charging and discharging conditions of individual electric vehicles belonging to the cluster.

The second processing unit 112 may limit a first boundary that defines a power range of the virtual battery and a second boundary that defines an energy range of the virtual battery for each time slot according to the charging and discharging conditions of the individual electric vehicles. The second processing unit 112 may generalize cases in which the charging and discharging conditions of the individual electric vehicles, such as charging and discharging outputs of the charger, cannot be satisfied to generate restriction conditions and derive maximum and minimum boundaries of charging and discharging powers of the charger and the available energy of the electric vehicle that satisfy the charging demand of the electric vehicle within a range that does not violate the restriction conditions.

In an example embodiment, the power range of the virtual battery may refer to the amount of power [kWh] of the charger (e.g., required) to provide the charging demand of the individual electric vehicle for the time when an electric vehicle is plugged-in a charger.

In an example embodiment, the energy range of the virtual battery may refer to the amount of energy [kWh] to be secured to provide the charging demand of the individual electric vehicle for the time when an electric vehicle is plugged-in a charger. This may refer to a range of the cumulative charge and discharge amount that can be secured for an electric vehicle plugged-in the charger for a predetermined time.

The second processing unit 112 may limit the first boundary and the second boundary according to the target SoC. The second processing unit 112 may limit the first boundary and the second boundary to follow the target SoC at a scheduled vehicle exit time according to scheduled vehicle exit time information. When it is determined that it is not possible to follow the target SoC at the scheduled vehicle exit time when discharging is performed in a first time slot, a maximum discharging range in the first time slot can be limited.

Alternatively, the second processing unit 112 may limit the first boundary and the second boundary according to battery capacity information. When it is determined that charging in a second time slot exceeds the battery capacity information, the second processing unit 112 may limit a maximum charging range in the second time slot.

In this case, the second processing unit 112 may limit the charging and discharging conditions of the individual electric vehicles by reflecting the output of the charger.

In addition, the second processing unit 112 may limit the first boundary and the second boundary by reflecting battery charging and discharging efficiency.

The second processing unit 112 may calculate a parking time according to scheduled vehicle entry and exit times of the electric vehicle and set first charging and discharging restriction conditions to the third charging and discharging restriction conditions considering a change in SoC of the electric vehicle according to the output of the charger and the charging and discharging efficiency for the parking time.

The second processing unit 112 may set the first charging and discharging restriction conditions to provide that the total energy provided by the charger to the electric vehicle for a given time does not exceed the total (e.g., required) charging amount of the electric vehicle. The second processing unit 112 may appropriately adjust the output of the charger through the first charging and discharging restriction conditions to satisfy the charging demand and efficiently manage energy.

For example, the second processing unit 112 may set the first charging and discharging restriction conditions according to Expression 1 below.

$${{\sum }^{{a}_{i} + {d}_{i}}}_{t = {a}_{i}} {P}_{i} ( t ) \times η \leq {C}_{i} \qquad [ Expression 1 ]$$

In Expression 1, aᵢ denotes a scheduled entry time of an electric vehicle connected to an i^{th} charger, di denotes a scheduled parking time of the electric vehicle connected to the i^{th} charger, Cᵢ denotes a charging amount of the electric vehicle connected to the i^{th} charger, Pᵢ(t) denotes an output of the i^{th} charger at time t, and n denotes battery charging and discharging efficiency of the electric vehicle.

Expression 1 represents a restriction condition that provides that the total charge amount of the i^{th} charger does not exceed the (e.g., required) charge amount of the electric vehicle. The first charging and discharging restriction conditions provide that the total energy provided by the charger to the electric vehicle for a given time does not exceed the total charging amount (e.g., required) by the electric vehicle.

The second processing unit 112 may set the second charging and discharging restriction conditions so that the charger (e.g., always) provides positive energy to the electric vehicle and energy does not flow in a reverse direction during the charging process. The second processing unit 112 may maintain the basic stability and efficiency of the charging system through the second charging and discharging restriction conditions.

For example, the second processing unit 112 may set the second charging and discharging restriction conditions according to Expression 2 below.

$${\sum }_{t = {a}_{i}}^{{a}_{i} + {d}_{i}} {P}_{i} ( t ) \times η \geq 0 \qquad [ Expression 2 ]$$

In Expression 2, aᵢ denotes a scheduled entry time of an electric vehicle connected to an i^{th} charger, di denotes a scheduled parking time of the electric vehicle connected to the i^{th} charger, Pᵢ(t) denotes an output of the i^{th} charger at time t, and η denotes battery charging and discharging efficiency of the electric vehicle.

Expression 2 limits that the charge amount should (e.g., always) be greater than or equal to zero during the charging process of the electric vehicle. That is, Expression 2 may refer to a restriction condition that the charger should not operate in the reverse direction and take energy out from the battery during the charging process.

The second processing unit 112 may set the third charging and discharging restriction conditions so that the total energy provided by the charger to the electric vehicle for a total parking time does satisfies the total (e.g., required) charging amount of the electric vehicle. The second processing unit 112 may appropriately set the output of the charger through the third charging and discharging restriction conditions and efficiently manage energy and satisfy the charging demand.

For example, the second processing unit 112 may set the third charging and discharging restriction conditions according to Expression 3 below.

$${\sum }_{t = {a}_{i}}^{{a}_{i} + {h}_{i}} {P}_{i} ( t ) \times η = {e}_{i} \qquad [ Expression 3 ]$$

In Expression 3, aᵢ denotes a scheduled entry time of an electric vehicle connected to an i^{th} charger, hi denotes a total scheduled parking time of the electric vehicle connected to the i^{th} charger, eᵢ denotes a charging amount of the electric vehicle connected to the i^{th} charger, Pᵢ(t) denotes an output of the i^{th} charger at time t, and η denotes battery efficiency of the electric vehicle.

The second processing unit 112 may limit the output of the charger to satisfy the target SoC considering the battery efficiency for the total parking time according to the third charging and discharging restriction conditions.

The second processing unit 112 may set the first boundary using the first charging and discharging restriction conditions to the third charging and discharging restriction conditions. The second processing unit 112 may set the largest value among the charging powers of the charger satisfying the first charging and discharging restriction conditions to the third charging and discharging restriction conditions as upper limit charging power of the corresponding time slot and calculate the charging power range according to the upper limit charging power. In addition, the second processing unit 112 may set the largest value among the discharging powers of the charger satisfying the first charging and discharging restriction conditions to the third charging and discharging restriction conditions as upper limit discharging power of the corresponding time slot and calculate the discharging power range according to the upper limit discharging power. The second processing unit 112 may limit the first boundary to a region including the charging power range and the discharging power range.

In addition, the second processing unit 112 may set the second boundary using the first charging and discharging restriction conditions to the third charging and discharging restriction conditions. The second processing unit 112 may set the largest value among the total of the charging outputs of the charger satisfying the first charging and discharging restriction conditions to the third charging and discharging restriction conditions as upper limit charging energy of the corresponding time slot and calculate the charging energy range according to the upper limit charging energy. In addition, the second processing unit 112 may set the largest value among the discharging outputs of the charger satisfying the first charging and discharging restriction conditions to the third charging and discharging restriction conditions as upper limit discharging energy of the corresponding time slot and calculate the discharging energy range according to the upper limit discharging energy. The second processing unit 112 may limit the second boundary to a region including the maximum charging energy range and the maximum discharging energy range.

The third processing unit 113 may integrate the battery resources of the electric vehicles in the cluster by reflecting the limited charging and discharging conditions and generate one virtual battery for each cluster.

The third processing unit 113 may sum the resources of the individual electric vehicles of which first and second boundaries are limited for each time slot and generate a virtual battery.

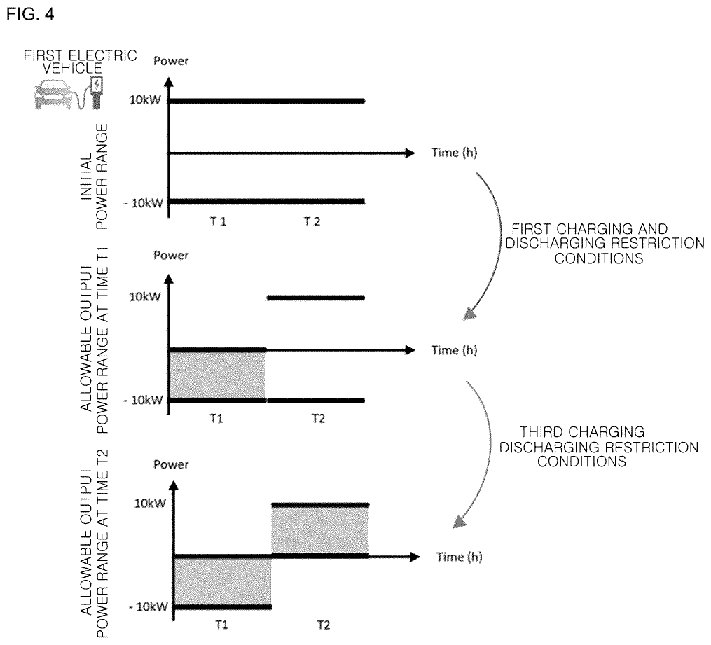

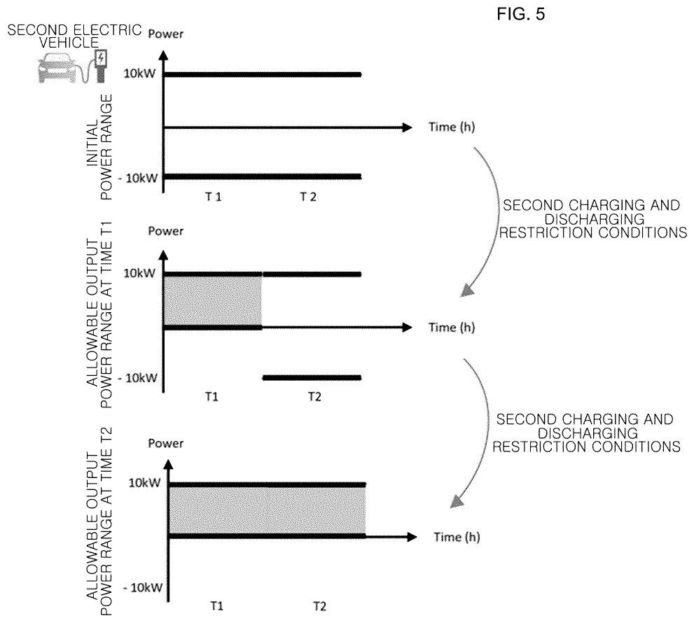

FIGS. 4 and 5 are views for describing the operation of a second processing unit according to an example embodiment. Referring to FIG. 4 together, a battery capacity of a first electric vehicle is set to 100 [kWh], an SoC at the time of entry is set to 100%, and the target SoC is set to 100%. The first electric vehicle is scheduled to enter at time point 0 and exit at time point T, an initial charging output of the charger is set to 10 [KW], and an initial discharging output is set to −10 [KW].

Since the SoC exceeds the battery capacity as 110% when charging the first electric vehicle in a first time slot T1, the second processing unit 112 may limit upper limit output power in the first time slot to 0 [KW] according to the first charging and discharging restriction conditions.

In addition, since an SoC at the scheduled vehicle exit time point does not satisfy the target SoC under (e.g., all) possible charging and discharging conditions when discharging the first electric vehicle in a second time slot T2, the second processing unit 112 may limit the upper limit discharging power in the second time slot to 0 [KW] according to the third charging and discharging restriction conditions.

Referring to FIG. 5 together, a battery capacity of a second electric vehicle is set to 100 [kWh], an SoC at the time of entry is set to 100%, and the target SoC is set to 100%. The second electric vehicle is scheduled to enter at time point 0 and exit at time point T, an initial charging output of the charger is set to 10 [KW], and an initial discharging output is set to −10 [KW].

Since an SoC at a scheduled vehicle exit time point does not satisfy the target SoC under (e.g., all) possible charging and discharging conditions when discharging the second electric vehicle in the first time slot T1, the second processing unit 112 may limit the upper limit discharging power in the first time slot to 0 [KW] according to the third charging and discharging restriction conditions.

In addition, since an SoC at the scheduled vehicle exit time point t does not satisfy the target SoC under (e.g., all) possible charging and discharging conditions when discharging the second electric vehicle in the second time slot T2, the second processing unit 112 may limit the discharging upper limit power in the second time slot to 0 [KW] according to the third charging and discharging restriction conditions.

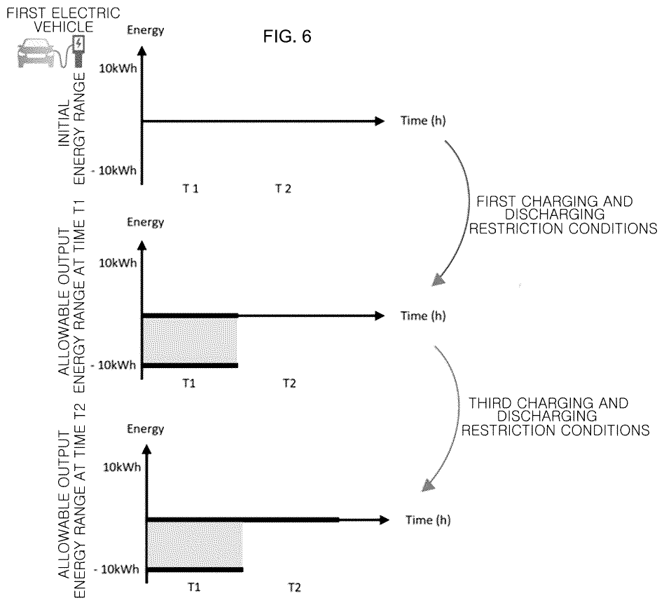

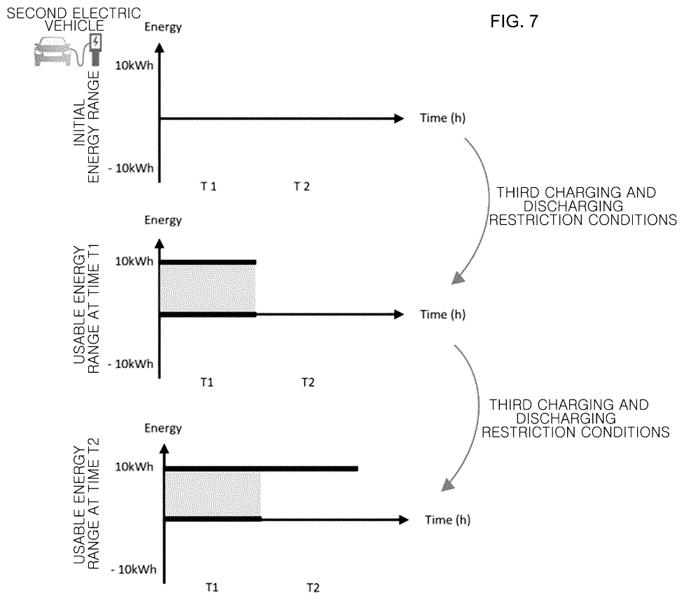

FIGS. 6 and 7 are views for describing the operation of a second processing unit according to another embodiment. Referring to FIG. 6 together, the battery capacity of the first electric vehicle is set to 100 [kWh], an SoC at the time of entry is set to 100%, and the target SoC is set to 100%. The first electric vehicle is scheduled to enter at time point 0 and exit at time point T.

Since the SoC exceeds the battery capacity as 110% when charging the first electric vehicle in the first time slot T1, the second processing unit 112 may limit upper limit charging energy in the first time slot to 0 [KW] according to the first charging and discharging restriction conditions.

In addition, since an SoC at the scheduled vehicle exit time point does not satisfy the target SoC under (e.g., all) possible charging and discharging conditions when discharging the first electric vehicle in the second time slot T2, the second processing unit 112 may limit the upper limit discharging energy in the second time slot to 0 [KW] according to the third charging and discharging restriction conditions.

In addition, the second processing unit 112 may calculate the energy range that may be secured so that the SoC of the electric vehicle is 100% at the scheduled vehicle exit time point based on the upper limit charging energy in the first time slot and the upper limit discharging energy in the second time slot.

Referring to FIG. 5 together, a battery capacity of a second electric vehicle is set to 100 [kWh], an SoC at the time of entry is set to 100%, and the target SoC is set to 100%. The second electric vehicle is scheduled to enter at time point 0 and exit at time point T.

Since an SoC at the scheduled vehicle exit time point does not satisfy the target SoC under (e.g., all) possible charging and discharging conditions when discharging the second electric vehicle in the first time slot T1, the second processing unit 112 may limit the upper limit discharging energy in the first time slot to 0 [KW] according to the third charging and discharging restriction conditions.

In addition, since the SoC at the scheduled vehicle exit time point does not satisfy the target SoC under (e.g., all) possible charging and discharging conditions when discharging the second electric vehicle in the second time slot T2, the second processing unit 112 may limit the upper limit discharging energy in the second time slot to 0 [KW] according to the third charging and discharging restriction conditions.

In addition, the second processing unit 112 may calculate the energy range that may be secured so that the SoC of the electric vehicle is 100% at the scheduled vehicle exit time point based on the upper limit discharging energy in the first time slot and the upper limit discharging energy in the second time slot.

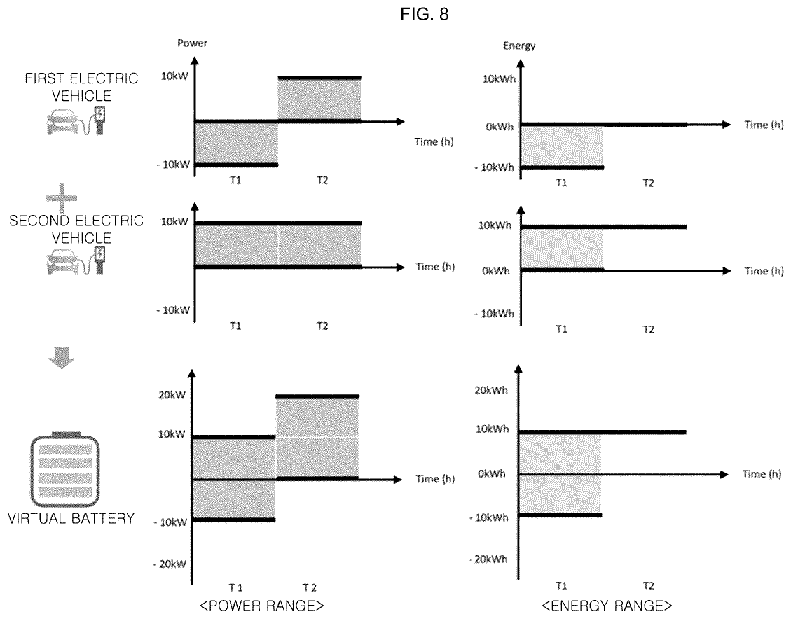

FIG. 8 is a view for describing the operation of a third processing unit according to an example embodiment. Referring to FIG. 8 together, the third processing unit 113 may sum the resources of the individual electric vehicles of which first and second boundaries are limited for each time slot and generate a virtual battery.

For example, the third processing unit 113 may sum the resources of the individual electric vehicles with the limited first boundary and generate a virtual battery as illustrated in FIG. 8A. In this case, the virtual battery limits the power amount [KW] of the charger (e.g., required) to provide the charging demand of the electric vehicle during charging and discharging of the electric vehicles in the cluster for each time slot.

For example, the third processing unit 113 may sum the resources of the individual electric vehicles with the limited second boundary and generate the virtual battery as illustrated in FIG. 8B. In this case, the virtual battery limits the energy amount [kWh] of the charger (e.g., required) to provide the charging demand of the electric vehicle during charging and discharging of the electric vehicles in the cluster for each time slot.

The fourth processing unit 114 may generate charging and discharging schedules of an electric vehicle using the virtual battery. The fourth processing unit 114 may generate charging and discharging schedules that satisfy difference transaction, a demand response (DR), and a target SoC that are collected through a communication device within the power range and energy range of the virtual battery.

For example, the fourth processing unit 114 may set at least one of whether charging and discharging are performed for each electric vehicle, the upper limit charging and discharging amounts considering the entry time, the target SoC set for the electric vehicle, and contracted power compliance conditions when participating in the demand response to a restriction function and set the difference transaction and the DR amount to an objective function to perform charging and discharging scheduling.

In an example embodiment, various objective functions may be applied for optimal charging and discharging scheduling. For example, goals such as minimizing an electricity cost, maximizing a battery lifetime, optimizing a load of a power grid, or the like may be applied.

For example, when the charging and discharging scheduling is requested, the fourth processing unit 114 may generate charging and discharging schedule information that maximizes the objective function based on profits.

For example, the fourth processing unit 114 may set the charging and discharging schedules to follow the target SoC of the individual electric vehicle based on the DR amount for each cluster.

The charging and discharging schedules may include the charging power amount and the discharging power amount of the individual electric vehicle for each cluster. In this case, the fourth processing unit 114 may determine the charging and discharging power amounts of the individual electric vehicle to follow the target SoC of the individual electric vehicle. The fourth processing unit 114 may set the charging and discharging schedules so that a difference value between the SoC of the electric vehicle and the target SoC after actual charging or discharging according to the charging and discharging schedules is a minimum value. In this case, the fourth processing unit 114 may set an SoC upper limit value and an SoC lower limit value according to an available capacity range of a battery of the individual electric vehicle and set the charging and discharging schedules so that the electric vehicle may be charged and discharged within the range of the SoC upper limit value and the SoC lower limit value.

For example, the fourth processing unit 114 may set the difference value between the SoC of the electric vehicle after the charging and discharging control and the target SoC to an objective function and minimize the difference value through an optimization process of the set objective function.

Alternatively, the fourth processing unit 114 may set the charging and discharging schedules so that the profit through the sum of the charging fee and the discharging profit is maximized. For example, the fourth processing unit 114 may set a price that sums a price of purchasing power for charging after charging and discharging control and a price of selling power through discharging to the objective function and minimize the difference value through the optimization process of the set objective function.

The fourth processing unit 114 may optimize the objective function by adapting a gradient descent method, a steepest descent method, or a stochastic gradient descent method.

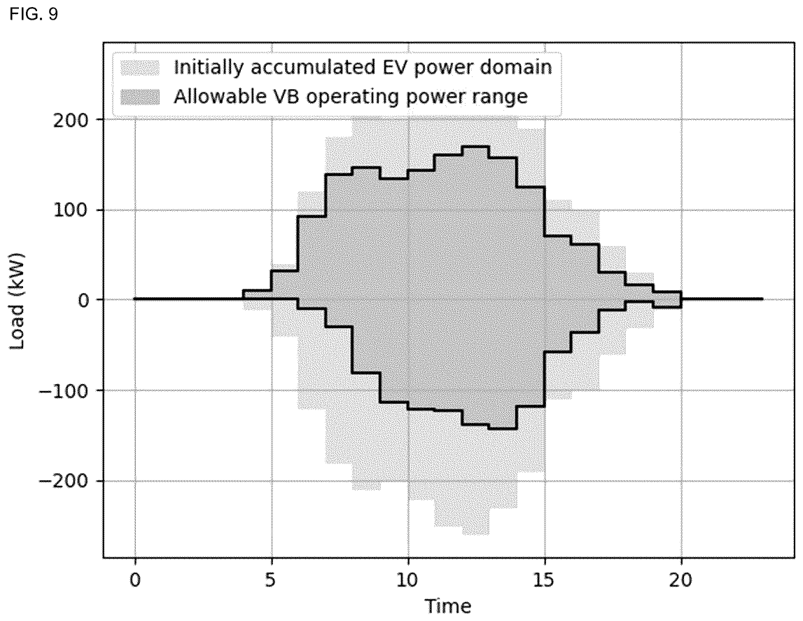

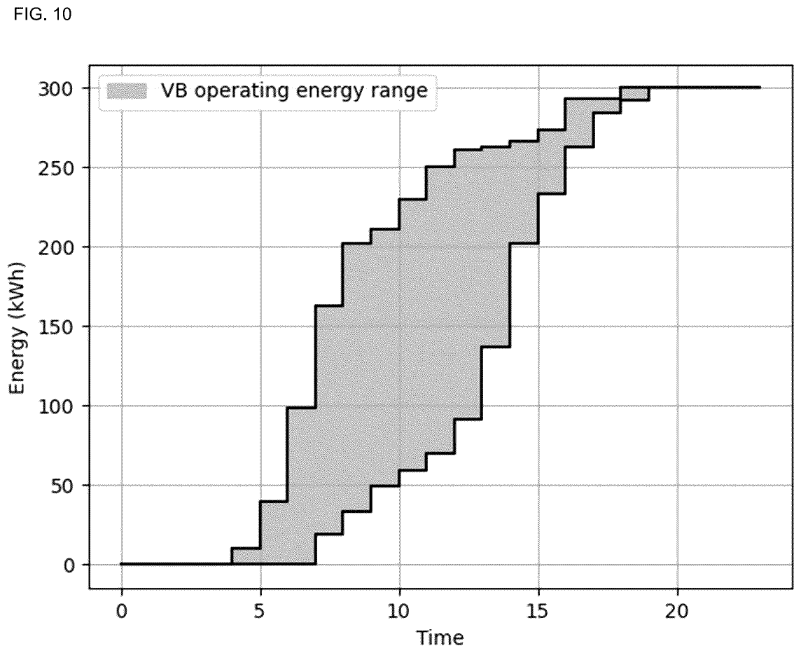

FIGS. 9 and 10 are views for describing a virtual battery according to an example embodiment. Referring to FIG. 9, a hatched region represents the first boundary that defines the power range of the virtual battery according to the embodiment, and a shaded region represents the power range calculated by simply multiplying the number of electric vehicles by the output of the charger according to the conventional technology. When three electric vehicles are connected to a charger having a charging and discharging output of 10 [KW], a total output of 30 kW may be derived as in the shaded region. However, there are actual cases in which the output cannot be generated at a specific time to satisfy the charging amount (e.g., required) by the charging conditions of the individual electric vehicles, such as the battery capacity of the electric vehicle, the initial SoC, the vehicle entry and exit times, etc. Accordingly, even when the virtual battery is generated by performing clustering on a plurality of electric vehicles, it is difficult to have a power range corresponding to the shaded region. The virtual battery according to the embodiment may derive restriction conditions according to the charging and discharging conditions of the individual electric vehicles before clustering, limit the power range of each electric vehicle using the restriction conditions, and then generate a virtual battery, thereby satisfying the actual charging and discharging conditions of the individual electric vehicles.

Referring to FIG. 10, the hatched region represents the second boundary that defines the energy range of the virtual battery according to the embodiment. In terms of energy, there is a range of energy to be secured for each time period to provide the target SoC when the electric vehicle exits, such as an output of a charger, a charging demand amount, a parking time, etc. The virtual battery according to the embodiment may derive restriction conditions according to the charging and discharging conditions of the individual electric vehicles before clustering, limit the power range of each electric vehicle using the restriction conditions, and then generate a virtual battery, thereby satisfying the actual charging and discharging conditions of the individual electric vehicles.

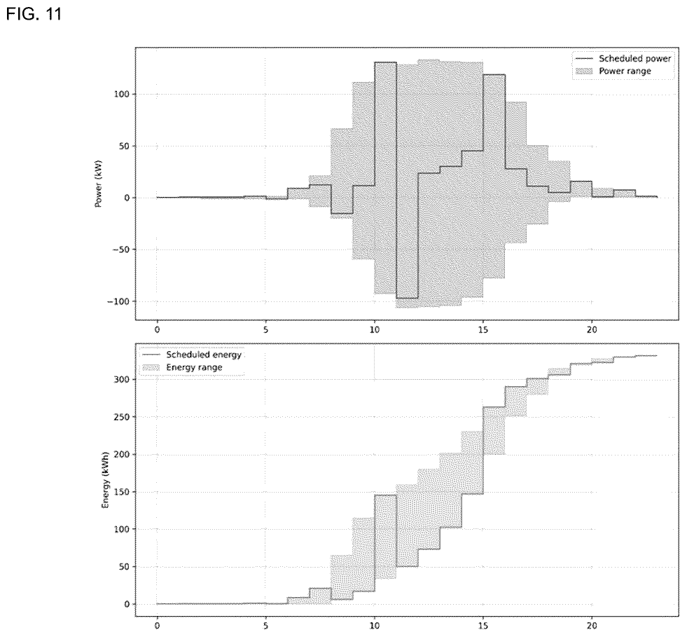

FIG. 11 is a view for describing charging and discharging schedules using the VB according to an example embodiment. A graph illustrated in FIG. 11 is a graph that is a result of generating a virtual battery using information on an electric vehicle that has entered a charging station on day D−1 and then performing the (e.g., entire) charging and discharging scheduling according to the purpose of the charging station on day D.

In FIG. 11A, a hatched region represents the power range of the virtual battery, and a bar graph represents charging and discharging power according to the charging and discharging scheduling. In FIG. 11A, it can be shown that the output of the virtual battery increases due to an increase in the number of electric vehicles during the daytime (10:00 to 18:00) and it can be shown that the output of the virtual battery decreases due to a decrease in the number of electric vehicles during the morning (5:00 to 10:00) and the nighttime (18:00 to 5:00). In addition, it can be shown that the charging and discharging scheduling was generated like the bar graph within the power range of the virtual battery.

Referring to FIG. 11B, a hatched region represents the energy range of the virtual battery, and a bar graph represents charging and discharging energy according to the charging and discharging scheduling. The energy range of the virtual battery represents the range of the cumulative charging and discharge amount that can be secured for electric vehicles that enter and exit the charging station during the day, and it can be shown that the charging and discharging scheduling is generated like the bar graph within the energy range of the virtual battery.

As described above, the charging and discharging scheduling may be calculated by adapting various objective functions.

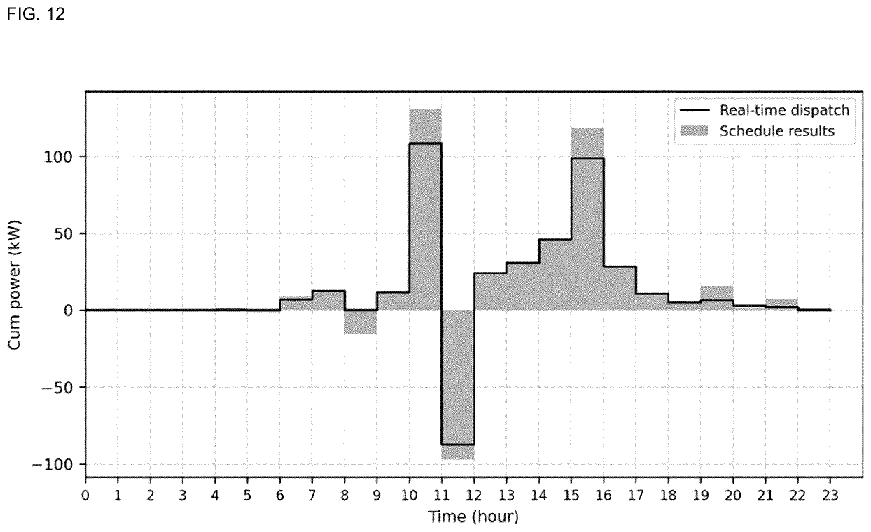

FIGS. 12 to 14 are views for describing reliability of charging and discharging scheduling generated according to an example embodiment. Referring to FIG. 12, a solid line represents the result of actually charging and discharging the electric vehicle that enters and exits during an experimental period, and a dotted line represents the charging and discharging schedules generated using the virtual battery according to the embodiment. Comparing the solid line with the dotted line, it can be shown that the result of actually charging and discharging the electric vehicle in (e.g., all) time periods during the experimental period follows the charging and discharging schedules generated using the virtual battery within an error range.

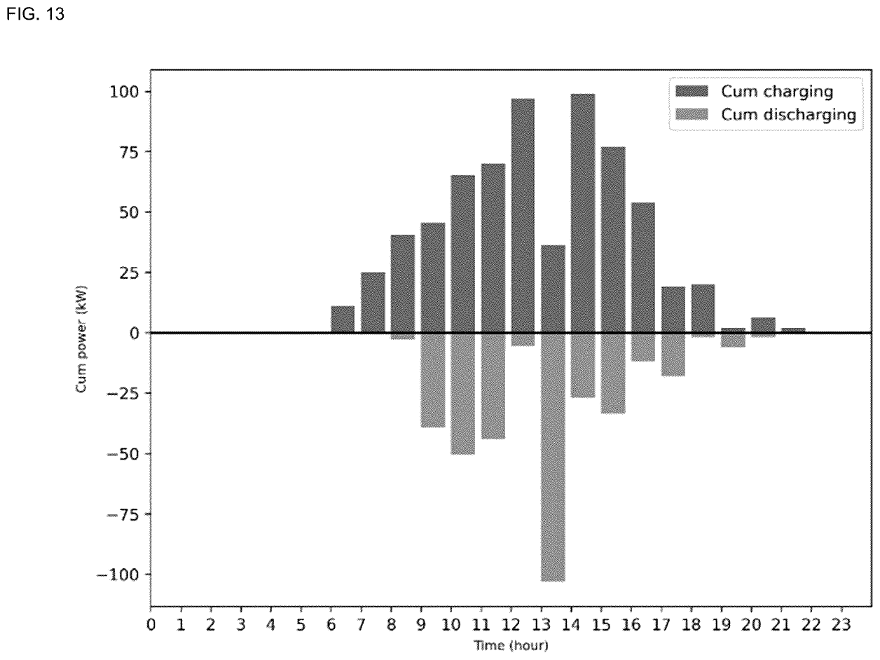

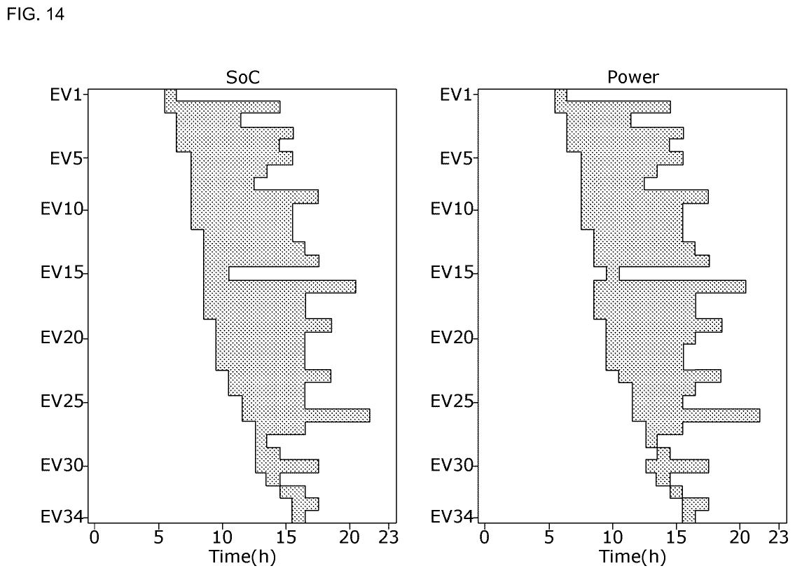

Referring to FIGS. 13 and 14, it can be shown that as the result of actually charging and discharging the electric vehicle using the charging and discharging schedules of the electric vehicle generated according to FIG. 11, the SoC and output of the individual electric vehicle are accurately followed.

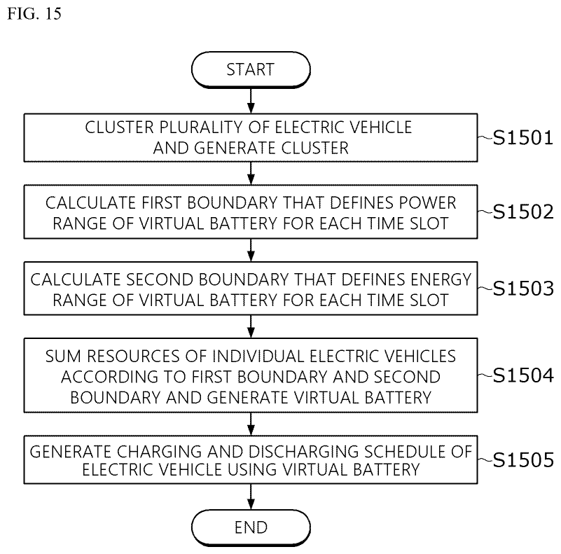

FIG. 15 is a flowchart illustrating a method of scheduling electric vehicle charging and discharging according to an example embodiment.

Referring to FIG. 15, first, a processor clusters a plurality of electric vehicles and generates at least one cluster (S1501).

Next, the processor calculates a first boundary that defines a power range of a virtual battery for each time slot according to charging and discharging conditions of an individual electric vehicle (S1502).

Next, the processor calculates a second boundary that defines an energy range of the virtual battery for each time slot according to the charging and discharging conditions of the individual electric vehicles (S1503).

A process of calculating the first boundary and a process of calculating the second boundary may be performed simultaneously or one process may be performed prior to the other.

Next, the processor sums resources of individual electric vehicles according to the first boundary and the second boundary for each time slot and generates a virtual battery (S1504).

Next, the processor generates charging and discharging schedules of an electric vehicle using a virtual battery (S1505).

The term “unit” used in the present embodiment means a software or hardware component such as a field-programmable gate array (FPGA) or an ASIC, and the “unit” performs certain roles. However, the “unit” is not limited to software or hardware. The “unit” may be disposed in an addressable storage medium and reproduce one or more processors. Therefore, as an example, the “unit” is components such as software components, object-oriented software components, class components, and task components, processes, functions, attributes, procedures, subroutines, segments of program code, drivers, firmware, microcode, circuits, data, database, data structures, tables, arrays, and variables. Functions provided in the components and “units” may be combined into the smaller number of components and “unit” or separated into additional components and “units.” Additionally, the components and “units” may be implemented to reproduce one or more CPUs in a device or a security multimedia card.

A device and method for managing charging and discharging of an electric vehicle according to embodiments can operate and manage a large number of electric vehicles as one resource by adapting a virtual battery (V B) technique.

In addition, it is possible to optimize power and energy parameters of a VB.

In addition, the VB can be operated considering power and energy at the same time.

In addition, a large number of electric vehicles can be used as a flexible resource of a power system through an operation algorithm of an electric vehicle aggregator system.

Although the present disclosure has been described above with reference to example embodiments, those skilled in the art will understand that the present disclosure may be modified and changed variously without departing from the spirit and scope of the present disclosure as described in the appended claims.

What is claimed is:

1. An electrical vehicle control device for managing charging and discharging of an electric vehicle, comprising:
a memory storing computer-executable instructions; and
at least one processor configured to access the memory and execute the instructions, wherein the instructions comprise:
clustering, via a first processing unit, a plurality of electric vehicles to generate a cluster;
limiting charging and discharging conditions, via a second processing unit, for a time period according to charging and discharging conditions of individual electric vehicles of the plurality of electric vehicles belonging to the cluster;
providing, via a third processing unit, the limited charging and discharging conditions for the time period;
integrating battery resources of the individual electric vehicles in the cluster; and
generating a virtual battery for the cluster.

2. The electrical vehicle control device of claim 1, wherein the charging and discharging conditions of the individual electric vehicles include at least one of plug-in charger information, a current state of charge (SoC), a target SoC, resource type information, battery capacity information, a battery charging efficiency, a battery discharging efficiency, scheduled vehicle entry time information, and scheduled vehicle exit time information.

3. The electrical vehicle control device of claim 2, wherein the instructions further comprise calculating, via the second processing unit, a first boundary that defines a power range of the virtual battery and a second boundary that defines an energy range of the virtual battery for the time period according to the charging and discharging conditions of the individual electric vehicles.

4. The electrical vehicle control device of claim 3, wherein the instructions further comprise limiting, via the second processing unit, the first boundary and the second boundary to follow the target SoC at a scheduled vehicle exit time according to the scheduled vehicle exit time information.

5. The electrical vehicle control device of claim 4, wherein, the instructions further comprise, when following of the target SoC is not possible at the scheduled vehicle exit time during discharging in a first time period, limiting, via the second processing unit, a discharging range in the first time period.

6. The electrical vehicle control device of claim 2, wherein the instructions further comprise, when charging in a second time period exceeds the battery capacity information, limiting, via the second processing unit, a charging range in the second time period.

7. The electrical vehicle control device of claim 3, wherein the instructions further comprise summing, via the third processing unit, resources of the individual electric vehicles according to the first boundary and the second boundary for the time period and generating the virtual battery.

8. The electrical vehicle control device of claim 1, wherein the instructions further comprise providing, via the second processing unit, an output of a charger and limiting the charging and discharging conditions of the individual electric vehicles.

9. The electrical vehicle control device of claim 3, wherein the instructions further comprise providing, via the second processing unit, battery charging and discharging efficiency and limiting the first boundary and the second boundary.

10. The electrical vehicle control device of claim 1, wherein the instructions further comprise generating, via a fourth processing unit, a charging and discharging schedule of the electric vehicle using the virtual battery.

11. A method of managing charging and discharging of an electric vehicle, which is performed by a computing device, a memory storing computer-executable instructions, and at least one processor configured to access the memory and execute the instructions, the method comprising:
clustering, by the processor, a plurality of electric vehicles and generating at least one cluster;
limiting, by the processor, charging and discharging conditions for a time period according to charging and discharging conditions of individual electric vehicles of the plurality of electric vehicles belonging to the cluster;
providing, by the processor, the limited charging and discharging conditions for the time period to integrate battery resources of the individual electric vehicles in the cluster; and
generating, by the processor, a virtual battery for the cluster.

12. The method of claim 11, wherein the charging and discharging conditions of the individual electric vehicles include at least one of plug-in charger information, a current state of charge (SoC), a target SoC, resource type information, battery capacity information, a battery charging efficiency, a battery discharging efficiency, scheduled vehicle entry time information, and scheduled vehicle exit time information.

13. The method of claim 12, wherein the limiting of the charging and discharging conditions for the time period includes:
calculating a first boundary that defines a power range of the virtual battery for a time slot according to the charging and discharging conditions of the individual electric vehicles; and
calculating a second boundary that defines an energy range of the virtual battery for the time slot according to the charging and discharging conditions of the individual electric vehicles.

14. The method of claim 13, wherein the limiting of the charging and discharging conditions for the time period includes limiting the first boundary and the second boundary to follow the target SoC at a scheduled vehicle exit time according to the scheduled vehicle exit time information.

15. The method of claim 14, wherein the limiting of the charging and discharging conditions for the time period includes limiting a discharging range in a first time slot when following of the target SoC is not possible at the scheduled vehicle exit time during discharging in the first time slot.

16. The method of claim 12, wherein the limiting of the charging and discharging conditions for the time period includes limiting a charging range in a second time slot when charging in the second time slot exceeds the battery capacity information.

17. The method of claim 13, wherein the generating of the virtual battery includes summing resources of the individual electric vehicles according to the first boundary and the second boundary for a time slot and generating the virtual battery.

18. The method of claim 11, wherein the limiting of the charging and discharging conditions for the time period includes reflecting an output of a charger and limiting the charging and discharging conditions of the individual electric vehicles.

19. The method of claim 13, wherein the limiting of the charging and discharging conditions for the time period includes providing the battery charging and discharging efficiency and limiting the first boundary and the second boundary.

20. The method of claim 11, further comprising generating charging and discharging schedules of the electric vehicle using the virtual battery.
